(19) United States
(12) Patent Application Publication
(10) Pub. No.: US 2007/0153441 A1
(43) Pub. Date: Jul. 5, 2007

(54) Voltage-responsive protection device, and lamp-string apparatus that incorporates the same

(76) Inventor: Chien-Chin Hsiao, Hsin-Chu City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 11/325,836

(22) Filed: Jan. 5, 2006

(51) Int. Cl. H02H 9/04

(52) U.S. Cl. 361/91.1

(57) ABSTRACT

A voltage-responsive protection device includes a current blocking unit disposed between a resistive element and a conductive unit. The current blocking unit prevents current flow between the resistive element and the conductive unit when an applied voltage across the voltage-responsive protection device does not exceed a predetermined rated voltage, and permits current flow between the resistive element and the conductive unit when the applied voltage exceeds the predetermined rated voltage. A lamp-string apparatus that incorporates the voltage-responsive protection device is also disclosed.

### BACKGROUND OF THE INVENTION

1. Field of the Invention

The invention relates to a voltage-responsive protection device, more particularly to a lamp-string apparatus that incorporates a voltage-responsive protection device.

2. Description of the Related Art

In a string of series connected lamps, the entire string of the lamps is inoperable when one of the lamps breaks down or falls off from the string. The following are two methods proposed in the art in order to overcome the above problem:

1. A protection device, such as a Zener diode, a transistor, a thyristor, etc., is connected electrically in parallel to each of the lamps, and is used to replace a corresponding one of the lamps when the corresponding lamp breaks down or falls off from the string. In use, a voltage applied across the protection device after the latter is activated is generally greater than an operating voltage of each lamp. As such, an increase in the number of the lamps that broke down or that fell off results in decreased brightness of the other lamps in the lamp string.

2. A connecting device, such as a metal oxide wire, is connected in parallel to each lamp of a string of series connected lamps, and a short-circuiting copper piece is installed in each lamp seat for providing a conducting path when any one of the lamps breaks down or falls off from the string. When some of the lamps in the lamp string break down, the load voltage of the other lamps, the current flowing therethrough, and the operating temperature will increase, thereby damaging more lamps.

### SUMMARY OF THE INVENTION

Therefore, the main object of the present invention is to provide a voltage-responsive protection device for a lamp-string apparatus that can eliminate the aforesaid drawbacks of the prior art.

According to one aspect of the present invention, a voltage-responsive protection device comprises:

a resistive element;

a conductive unit; and

a current blocking unit disposed between the resistive element and the conductive unit, the current blocking unit preventing current flow between the resistive element and the conductive unit when an applied voltage across the voltage-responsive protection device does not exceed a predetermined rated voltage, and permitting current flow between the resistive element and the conductive unit when the applied voltage exceeds the predetermined rated voltage.

According to another aspect of the present invention, a packaged voltage-responsive protection device comprises:

a resistor having opposite first and second ends;

a first diode having a first anode coupled electrically to the first end of the resistor, and a first cathode that serves as a first external electrode; and

a second diode having a second anode coupled electrically to the second end of the resistor, and a second cathode that serves as a second external electrode.

According to a further aspect of the present invention, a lamp-string apparatus comprises:

a string of series connected lamps; and

a plurality of voltage-responsive protection devices, each of which is connected electrically in parallel to a respective of the lamps, each of the voltage-responsive protection devices including
a resistive element,
a conductive unit, and

a current blocking unit disposed between the resistive element and the conductive unit, the current blocking unit preventing current flow between the resistive element and the conductive unit when a lamp voltage of the respective one of the lamps does not exceed a predetermined rated voltage, and permitting current flow between the resistive element and the conductive unit when the lamp voltage exceeds the predetermined rated voltage.

According to still another aspect of the present invention, there is provided a method for fabricating a voltage-responsive protection device. The method comprises the steps of:

a) forming a semi-finished product that has a current blocking unit disposed between a resistive element and a conductive unit, the current blocking unit preventing current flow between the resistive element and the conductive unit when an applied voltage across the voltage-responsive protection device does not exceed a predetermined rated voltage, and permitting current flow between the resistive element and the conductive unit when the applied voltage exceeds the predetermined rated voltage; and

b) encapsulating the semi-finished product such that the conductive unit is partly exposed.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view showing the first preferred embodiment of a voltage-responsive protection device according to the present invention;

FIG. 2 is a schematic electrical circuit diagram illustrating a lamp-string apparatus that incorporates the first preferred embodiment;

FIG. 3 is an exploded perspective view showing the second preferred embodiment of a voltage-responsive protection device according to the present invention;

FIG. 4 is an exploded perspective view showing the third preferred embodiment of a voltage-responsive protection device according to the present invention;

FIG. 5 is an exploded perspective view showing the fourth preferred embodiment of a voltage-responsive protection device according to the present invention;

FIG. 6 is a schematic view showing the fifth preferred embodiment of a voltage-responsive protection device according to the present invention;

FIG. 7 is a schematic sectional view showing a packaged product of the fifth preferred embodiment;

FIG. 8 is a schematic view showing the sixth preferred embodiment of a voltage-responsive protection device according to the present invention;

FIG. 9 is an equivalent circuit diagram of the sixth preferred embodiment; and

FIG. 10 is a flow chart illustrating how the sixth preferred embodiment is fabricated according to the present invention.

### DETAILED DESCRIPTION OF THE PREFERRED EMBODIMENTS

Before the present invention is described in greater detail, it should be noted that like elements are denoted by the same reference numerals throughout the disclosure.

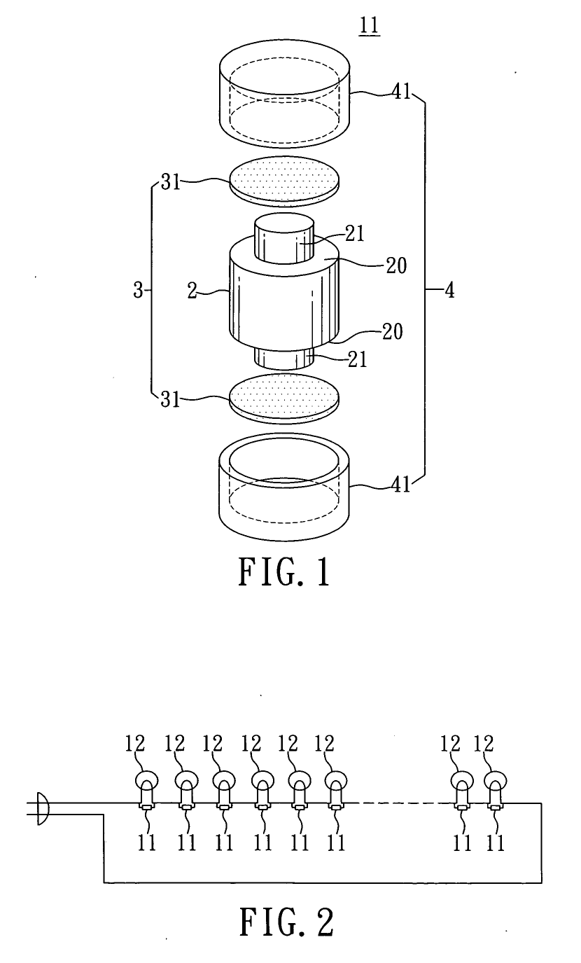

Referring to FIG. 1, the first preferred embodiment of a voltage-responsive protection device 11 according to the present invention is shown to include a resistive element 2, a conductive unit 4, and a current blocking unit 3.

The current blocking unit 3 is disposed between the resistive element 2 and the conductive unit 4. The current blocking unit 3 prevents current flow between the resistive element 2 and the conductive unit 4 when an applied voltage across the voltage-responsive protection device 11 does not exceed a predetermined rated voltage, and permits current flow between the resistive element 2 and the conductive unit 4 when the applied voltage exceed the predetermined rated voltage.

In this embodiment, the resistive element 2 is one of a carbon film resistor, a carbon rod resistor, a metal film resistor, a metal wire-wound resistor, a metal rod resistor, and a metal foil resistor, which are all commercially available. The resistive element 2 is formed with a cylindrical shape, and has opposite ends 20, each of which is formed with a terminal stub 21.

In this embodiment, the conductive unit 4 includes a pair of conductive members 41.

In this embodiment, the current blocking unit 3 is made from an insulator material selected from SiO₂ and Al₂O₃, and includes a pair of dielectric members 31, each of which is provided between a respective one of the conductive members 41 and a respective one of the opposite ends 20 of the resistive element 2. Each of the conductive members 41 is capped on the terminal stub 21 on a respective one of the opposite ends 20 of the resistive element 2. In this embodiment, each of the dielectric members 31 is in the form of a circular dielectric plate disposed between the respective one of the conductive members 41 and the terminal stub 21 on the respective one of the opposite ends 20 of the resistive element 2. Preferably, the predetermined rated voltage ranges from 20 volts to 80 volts.

FIG. 2 shows a lamp-string apparatus that incorporates a plurality of the voltage-responsive protection devices 11 of the first preferred embodiment. In the lamp-string apparatus, for example, there are provided a string of 50 series connected lamps 12, and 50 voltage-responsive protection devices 11, each of which is connected electrically in parallel to a respective of the lamps 12, wherein each lamp 12 has an operating voltage of 2.5 volts and a current specification of 0.17 Amp, i.e., an impedance of each lamp 12 is 14 Ohms, when a 120-volt AC power source is applied to the lamp-string apparatus. On the other hand, for each voltage-responsive protection device 11, an impedance of the resistive element 11 is set to be 14 Ohms, and the predetermined rated voltage is set to be 20˜80 volts (when each dielectric member 31 made from Al₂O₃ has a thickness of 2˜2.5 μm and a dielectric coefficient of 10˜35 kV/mm, each dielectric member 31 conducts when subjected to an applied voltage of about 20˜70 volts).

As such, in actual use, if each lamp 12 of the lamp-string apparatus is normal, each lamp 12 has an operating voltage of about 2.4 volts, which is greatly less than the predetermined rated voltage, such that the respective voltage-responsive protection device 11 prevents current flow between the resistive element 2 and the conductive unit 4 thereof. Therefore, the voltage-responsive protection devices 11 incorporated in the lamp-string apparatus do not affect operation of the lamps 12.

In contrast, if one of the lamps 12 breaks down or falls off from the string, an applied voltage at a location corresponding to said one of the lamps 12 increases quickly up to about 120 volts, which is greater than the predetermined rated voltage of 20˜80 volts, such that the voltage-responsive protection device 11 corresponding to the lamp 12 that broke down or that fell off permits current flow between the resistive element 2 and the conductive unit 4 thereof, and replaces the lamp 12 that broke down or that fell off due to the impedance of the resistive element 2 of the voltage-responsive protection device 11 being equal to that of each lamp 12, thereby enabling the lamp-string apparatus to continue operation in a normal state.

It is noted that the power source applied to the lamp-string apparatus is not limited to the 120-volt AC power source, and that the number of the lamps 12 is also not limited to 50. The thickness of the dielectric member 31, and the predetermined rated voltage can be decided based on the applied power source and the number of the lamps 12.

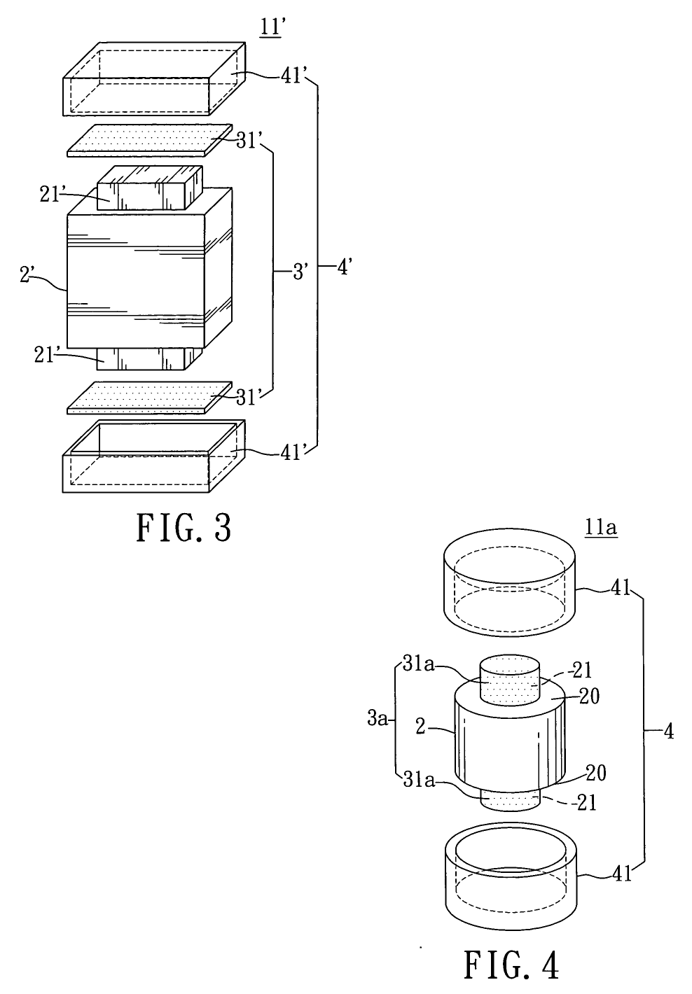

FIG. 3 illustrates the second preferred embodiment of a voltage-responsive protection device 11′ according to this invention, which is a modification of the first preferred embodiment. Unlike the previous embodiment, the shapes of the resistive element 2′, the conductive members 41′ of the conductive unit 4′, and the dielectric members 31′ of the current blocking unit 3′ are rectangular.

FIG. 4 illustrates the third preferred embodiment of a voltage-responsive protection device (11a) according to this invention, which is a modification of the first preferred embodiment. In this embodiment, each of the dielectric members (31a) of the current blocking unit (3a) is in the form of a dielectric coating formed on the terminal stub 21 on the respective one of the opposite ends 20 of the resistive element 2.

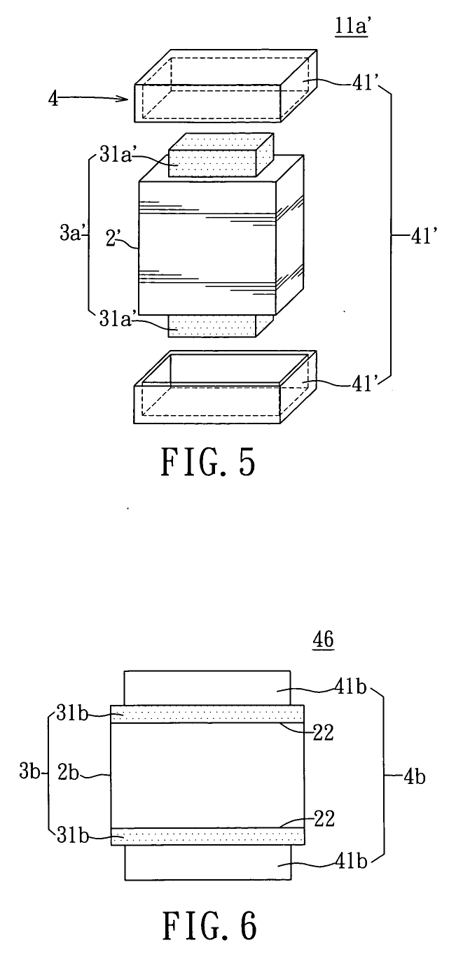

FIG. 5 illustrates the fourth preferred embodiment of a voltage-responsive protection device (11a′) according to this invention, which is a modification of the third preferred embodiment. Unlike the third preferred embodiment, the shapes of the resistive element 2′ and the conductive members 41′ of the conductive unit 4′ are rectangular.

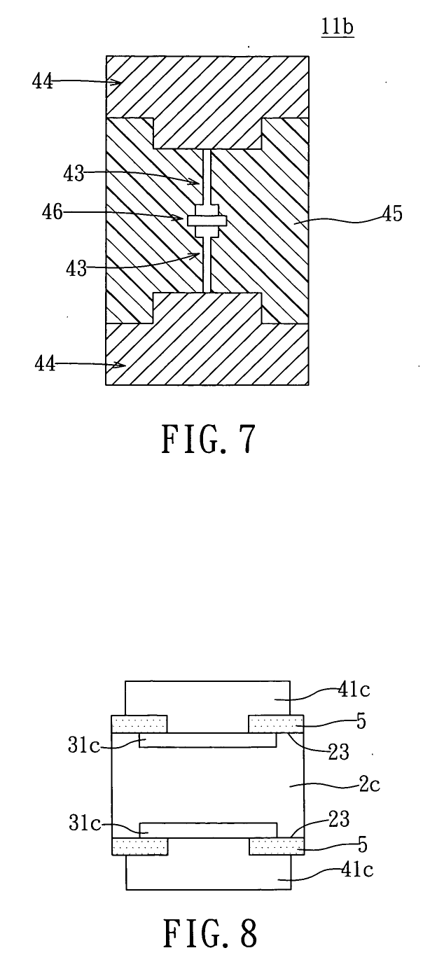

FIGS. 6 and 7 illustrate the fifth preferred embodiment of a voltage-responsive protection device (11b) according to this invention, which is a modification of the first preferred embodiment. FIG. 6 shows a semi-finished product of the voltage-responsive protection device (11b) that is formed as a die 46.

In this embodiment, the resistive element (2b) is made from a semiconductor material, which can be a p-type semiconductor material, and has opposite surfaces 22. When the voltage-responsive protection device (11b) is incorporated in the above-mentioned lamp-string apparatus, the p-type semiconductor material of the resistive element (2b) is fabricated to have an adequate thickness so that the resistive element (2b) has an impedance corresponding to that of a corresponding lamp 12 of the above-mentioned lamp-string apparatus.

In this embodiment, the current blocking unit (3b) includes a pair of dielectric layers (31b) made from an insulator material selected from SiO₂ and Al₂O₃. Each of the dielectric layers (31b) is formed on a respective one of the opposite surfaces 22 of the resistive element (2b) using convnetional CVD or PVD techniques such that each dielectric layer (31b) has an adequate thickness so as to match the requirements related to the predetermined rated voltage that ranges from 20 volts to 80 volts.

In this embodiment, the conductive unit (4b) includes a pair of metal layers (41b), which are made from Cu or Al. Each of the metal layers (41b) is formed on a respective one of the dielectric layers (31b) without extending therethrough.

Referring to FIG. 7, the die 46 is encapsulated by epoxy resin 45 such that each metal layer (41b) is connected electrically to a respective metal cap 44, which serves as an external electrode, via a corresponding lead 43. As such, the packaged voltage-responsive protection device (11b) is obtained in the fifth preferred embodiment.

FIG. 8 illustrates the sixth preferred embodiment of a voltage-responsive protection device (11c) according to this invention, which is a modification of the first preferred embodiment. Unlike the previous embodiments, the resistive element (2c) is made from a first semiconductor material, and has opposite surfaces 23. In this embodiment, the first semiconductor material is a p-type semiconductor material.

The current blocking unit is made from a second semiconductor material, and is in the form of a pair of doped regions (31c), each of which is formed on a respective one of the opposite surfaces 23 of the resistive element (2c). In this embodiment, the second semiconductor material is an n-type semiconductor material.

The conductive unit includes a pair of metal layers (41c), each of which is formed on a respective one of the doped regions (31c) without extending therethrough.

Furthermore, there are two oxide layers 5 made from SiO₂. Each of the oxide layers 5 is formed on a respective one of the opposite surfaces 23 of the resistive element (2c) for isolating the resistive element (2c) from a respective one of the metal layers (41c).

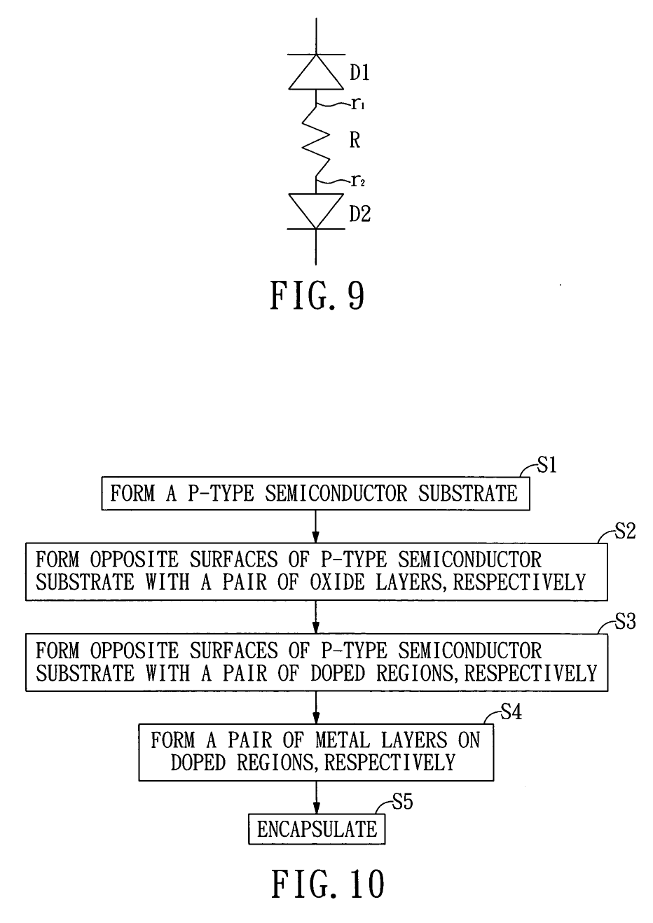

In such a configuration, two p-n junctions, each of which constitutes a diode, are formed. Therefore, an equivalent circuit diagram of the configuration shown in FIG. 8 is illustrated in FIG. 9, wherein a resistor (R) has first and second ends (r1, r2), a first diode (D1) has a first anode coupled electrically to the first end (r1) of the resistor (R), and a second diode (D2) has a second anode coupled electrically to the second end (r2) of the resistor (R).

FIG. 10 illustrates how the sixth preferred embodiment is fabricated according to the present invention. In step S1, a p-type semiconductor substrate is formed to result in the resistive element (2c). In step S2, a pair of oxide layers 5 are formed respectively on opposite surfaces of the p-type semiconductor substrate (i.e., the opposite surfaces 23 of the resistive element (2c)). In step S3, a pair of n-type doped regions (31c) are formed respectively on the opposite surfaces of the p-type semiconductor substrate to result in the current blocking unit. In step S4, a pair of metal layers (41c) are formed, and extend respectively through the oxide layers 5 and to the doped regions (31c) to result in the conductive unit. In step S5, a semi-finished product having the resistive element, the current blocking unit and the conductive unit is encapsulated such that the conductive unit is partly exposed.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A voltage-responsive protection device comprising:
a resistive element;
a conductive unit; and
a current blocking unit disposed between said resistive element and said conductive unit, said current blocking unit preventing current flow between said resistive element and said conductive unit when an applied voltage across said voltage-responsive protection device does not exceed a predetermined rated voltage, and permitting current flow between said resistive element and said conductive unit when the applied voltage exceeds the predetermined rated voltage.

2. The voltage-responsive protection device as claimed in claim 1, wherein said current blocking unit is made from an insulator material selected from SiO₂ and Al₂O₃.

3. The voltage-responsive protection device as claimed in claim 2, wherein said resistive element is one of a carbon film resistor, a carbon rod resistor, a metal film resistor, a metal wire-wound resistor, a metal rod resistor, and a metal foil resistor.

4. The voltage-responsive protection device as claimed in claim 3, wherein:
said resistive element has opposite ends;
said conductive unit includes a pair of conductive members; and
said current blocking unit includes a pair of dielectric members, each of which is provided between a respective one of said conductive members and a respective one of said opposite ends of said resistive element.

5. The voltage-responsive protection device as claimed in claim 4, wherein said resistive element is formed with a terminal stub at each of said opposite ends thereof.

6. The voltage-responsive protection device as claimed in claim 5, wherein each of said conductive members is capped on said terminal stub on a respective one of said opposite ends of said resistive element.

7. The voltage-responsive protection device as claimed in claim 6, wherein each of said dielectric members is in the form of a dielectric plate disposed between the respective one of said conductive members and said terminal stub on the respective one of said opposite ends of said resistive element.

8. The voltage-responsive protection device as claimed in claim 6, wherein each of said dielectric members is in the form of a dielectric coating formed on said terminal stub on the respective one of said opposite ends of said resistive element.

9. The voltage-responsive protection device as claimed in claim 1, wherein said resistive element is one of a carbon film resistor, a carbon rod resistor, a metal film resistor, a metal wire-wound resistor, a metal rod resistor, and a metal foil resistor.

10. The voltage-responsive protection device as claimed in claim 2, wherein said resistive element is made from a semiconductor material.

11. The voltage-responsive protection device as claimed in claim 10, wherein the semiconductor material is a p-type semiconductor material.

12. The voltage-responsive protection device as claimed in claim 10, wherein:
said resistive element has opposite surfaces; and
said current blocking unit includes a pair of dielectric layers, each of which is formed on a respective one of said opposite surfaces of said resistive element.

13. The voltage-responsive protection device as claimed in claim 12, wherein said conductive unit includes a pair of metal layers, each of which is formed on a respective one of said dielectric layers.

14. The voltage-responsive protection device as claimed in claim 1, wherein:
said resistive element is made from a first semiconductor material and has opposite surfaces;
said current blocking unit is made from a second semiconductor material and is in the form of a pair of doped regions, each of which is formed on a respective one of said opposite surfaces of said resistive element; and
said conductive unit includes a pair of metal layers, each of which is formed on a respective one of said doped regions.

15. The voltage-responsive protection device as claimed in claim 14, wherein the first semiconductor material is a p-type semiconductor material, and the second semiconductor material is an n-type semiconductor material.

16. The voltage-responsive protection device as claimed in claim 1, wherein the predetermined rated voltage ranges from 20 volts to 80 volts.

17. A packaged voltage-responsive protection device comprising:
a resistor having opposite first and second ends;
a first diode having a first anode coupled electrically to said first end of said resistor, and a first cathode that serves as a first external electrode; and
a second diode having a second anode coupled electrically to said second end of said resistor, and a second cathode that serves as a second external electrode.

18. A lamp-string apparatus comprising:
a string of series connected lamps; and
a plurality of voltage-responsive protection devices, each of which is connected electrically in parallel to a respective of said lamps, each of said voltage-responsive protection devices including
a resistive element,
a conductive unit, and
a current blocking unit disposed between said resistive element and said conductive unit, said current blocking unit preventing current flow between said resistive element and said conductive unit when a lamp voltage of the respective one of said lamps does not exceed a predetermined rated voltage, and permitting current flow between said resistive element and said conductive unit when the lamp voltage exceeds the predetermined rated voltage.

19. The lamp-string apparatus as claimed in claim 18, wherein said current blocking unit of each of said voltage-responsive protection devices is made from an insulator material selected from SiO₂ and Al₂O₃.

20. The lamp-string apparatus as claimed in claim 19, wherein said resistive element of each of said voltage-responsive protection devices is one of a carbon film resistor, a carbon rod resistor, a metal film resistor, a metal wire-wound resistor, a metal rod resistor, and a metal foil resistor.

21. The lamp-string apparatus as claimed in claim 20, wherein:
said resistive element of each of said voltage-responsive protection devices has opposite ends;
said conductive unit of each of said voltage-responsive protection devices includes a pair of conductive members; and
said current blocking unit of each of said voltage-responsive protection devices includes a pair of dielectric members, each of which is provided between a respective one of said conductive members and a respective one of said opposite ends of said resistive element.

22. The lamp-string apparatus as claimed in claim 21, wherein:
said resistive element of each of said voltage-responsive protection devices is formed with a terminal stub at each of said opposite ends thereof; and
each of said conductive members is capped on said terminal stub on a respective one of said opposite ends of said resistive element.

23. The lamp-string apparatus as claimed in claim 22, wherein each of said dielectric members is in the form of a dielectric plate disposed between the respective one of said conductive members and said terminal stub on the respective one of said opposite ends of said resistive element.

24. The lamp-string apparatus as claimed in claim 22, wherein each of said dielectric members is in the form of a dielectric coating formed on said terminal stub on the respective one of said opposite ends of said resistive element.

25. The lamp-string apparatus as claimed in claim 18, wherein said resistive element of each of said voltage-responsive protection devices is one of a carbon film resistor, a carbon rod resistor, a metal film resistor, a metal wire-wound resistor, a metal rod resistor, and a metal foil resistor.

26. The lamp-string apparatus as claimed in claim 19, wherein said resistive element of each of said voltage-responsive protection devices is made from a semiconductor material.

27. The lamp-string apparatus as claimed in claim 26, wherein the semiconductor material is a p-type semiconductor material.

28. The lamp-string apparatus as claimed in claim 26, wherein:
said resistive element of each of said voltage-responsive protection devices has opposite surfaces; and
said current blocking unit of each of said voltage-responsive protection devices includes a pair of dielectric layers, each of which is formed on a respective one of said opposite surfaces of said resistive element.

29. The lamp-string apparatus as claimed in claim 28, wherein said conductive unit of each of said voltage-responsive protection devices includes a pair of metal layers, each of which is formed on a respective one of said dielectric layers.

30. The lamp-string apparatus as claimed in claim 18, wherein:
said resistive element of each of said voltage-responsive protection devices is made from a first semiconductor material and has opposite surfaces;
said current blocking unit of each of said voltage-responsive protection devices is made from a second semiconductor material and is in the form of a pair of doped regions, each of which is formed on a respective one of said opposite surfaces of said resistive element; and
said conductive unit of each of said voltage-responsive protection devices includes a pair of metal layers, each of which is formed on a respective one of said doped regions.

31. The lamp-string apparatus as claimed in claim 30, wherein the first semiconductor material is a p-type semiconductor material, and the second semiconductor material is an n-type semiconductor material.

32. The lamp-string apparatus as claimed in claim 18, wherein said resistive element of each of said voltage-responsive protection devices has an impedance corresponding to that of the respective one of said lamps.

33. A method for fabricating a voltage-responsive protection device, comprising the steps of:
a) forming a semi-finished product that has a current blocking unit disposed between a resistive element and a conductive unit, the current blocking unit preventing current flow between the resistive element and the conductive unit when an applied voltage across the voltage-responsive protection device does not exceed a predetermined rated voltage, and permitting current flow between the resistive element and the conductive unit when the applied voltage exceeds the predetermined rated voltage; and
b) encapsulating the semi-finished product such that the conductive unit is partly exposed.

34. The method as claimed in claim 33, wherein the current blocking unit is made from an insulator material selected from SiO₂ and Al₂O₃.

35. The method as claimed in claim 34, wherein the resistive element is made from a semiconductor material.

36. The method as claimed in claim 35, wherein the semiconductor material is a p-type semiconductor material.

37. The method as claimed in claim 35, wherein step a) includes:
forming opposite surfaces of the resistive element with a pair of dielectric layers, respectively, to result in the current blocking unit; and
forming a pair of metal layers on the dielectric layers, respectively, to result in the conductive unit.

38. The method as claimed in claim 33, wherein the resistive element is made from a first semiconductor material, and wherein step a) includes:
forming opposite surfaces of the resistive element with a pair of oxide layers, respectively;
forming the opposite surfaces of the resistive element with a pair of doped regions, respectively, to result in the current blocking unit made from a second conductor material; and
forming a pair of metal layers that extend respectively through the oxide layers and to the doped regions to result in the conductive unit.

39. The method as claimed in claim 38, wherein the first semiconductor material is a p-type semiconductor material, and the second semiconductor material is an n-type semiconductor material.

40. The method as claimed in claim 33, wherein the predetermined rated voltage ranges from 20 volts to 80 volts.
